(19) United States
(12) Patent Application Publication
(10) Pub. No.: US 2005/0015877 A1
(43) Pub. Date: Jan. 27, 2005

(54) Electromotive bed

(76) Inventor: Daoyi Qi, Guiyan City (CN)

Correspondence Address: BAKER & HOSTETLER LLP, Washington Square, Suite 1100, 1050 Connecticut Avenue, N.W., WASHINGTON, DC, 20036, US

(21) Appl. No.: 10/892,123

(22) Filed: Jul. 16, 2004

(30) Foreign Application Priority Data
Jul. 18, 2003 (CN) CN 03135445.9
Jul. 18, 2003 (CN) CN 03249582.X
Jul. 18, 2003 (CN) CN 03249581.1

(51) Int. Cl. A61G 7/02; A61G 7/015

(52) U.S. Cl. 5/604; 5/618

(57) ABSTRACT

This invention is concerning with a kind of electromotive bed, on which a turnover device and a defecation device are installed, of which, the turnover device includes: a turnover supporting block; on which a plurality of shaft pin holes are formed bilaterally on the upper side and in which two holes are equipped separately with a shaft pin, and the turnover supporting block can be fixed rotatably in through holes with the shaft pins; a defector rod inserted in a slit opened in the lower portion of the turnover supporting block along the center line, and the other end of which connects to a deflector arm connecting to a load transfer device; the defecation device includes: a porefilling pad that can be contained in a hole, having a sleeve formed on its bottom surface; a spacer sleeve formed between the porefilling pad and a mattress; a sealed cowling fixed on the soleplate under the hole with its bottom hermetically connecting to a closestool; a mechanical linkage device connecting to the porefilling pad via the sleeve and connecting to a power installation. According to this invention, an electromotive bed, which is capable of turning over anti has a closestool, is simple in structure and convenient for use, and can prevent occurrence of the bedsore. Furthermore, the bed may be applied in common family because of its low price.

### TECHNICAL FIELD

This invention relates to a structure of health care electromotive bed, especially to an electromotive bed tat can turn the patient over and has a closestool.

### BACKGROUND TECHNIQUE

Generally speaking, the aged men, the disables and the patients who keep to their electromotive beds for a long time and feel difficult to move freely need to solve the problems of turnover and defecation on the electromotive bed, so that they can turn over for ventilation to avoid bedsore, and can relieve themselves on the electromotive bed conveniently, comfortably and hygienically.

Of the current techniques there is a kind of electromotive bed having a net sling. The action is that a device which may be used to lift the net sling up as required is fixed on the electromotive bed, so that the human body is lifted at the same time. Therefore, it realize the ventilation through mesh of the net sling and prevent the person keeping to the electromotive bed from catching diseases such as bedsore, etc. Such products are complicated in structure and inconvenient for use, and cannot provide users with natural and comfortable sense. Many other electromotive beds capable of turnover are also published on China patent gazette, but these electromotive beds usually divide the electromotive soleplate into two parts, of which, one part is immobilized and another part can be turned over to make human body turn around. But such turnover mode still keeps the whole back of the human body closely fitting on the electromotive mattress, and can not provide a ventilation condition. Therefore it is still difficult to avoid the bedsore caused by keeping to bed for a long time, bad ventilation and disinfection, and high humidity.

There are many kinds of existing electromotive beds with closestools, but most of them are without automatic jetter so that the people lying on the electromotive bed cannot clean himself. Whereas some products do have spray systems but water stream may be sprayed on the electromotive bed, clothing, and sometimes on other parts owing to the effect of the shape and plumpness of their bodies during operation, thereby result in inconveniences to the users. On the other hand, the person keeping to electromotive bed cannot deal with the defecation problem without a special people's help, because a removeable cushion at the relieving position on the electromotive bed can be taken down only with the cooperation of other people.

In a word, each kind of existing electromotive sickbed has various functions, but the above problems can not be solved completely; on the other hand, these products are complicated in structure and expensive in price, therefore they are difficult to be accepted by the common consumer.

### SUMMARY OF THE INVENTION

The invention is aimed at providing a kind of electromotive bed that can turn the human body over and has a closestool, which in the meantime enable the users of the electromotive bed to turn over or defecate themselves according to their own willing; furthermore, cleaning, drying and ventilation can be cared out and thus the people who lie on the electromotive bed for a long time are guaranteed being from the bedsore.

The electromotive bed provided by the technical proposal of this invention includes a bed body, 2-3 rectangular through holes are opened in the middle-upper portion of the mattress of the said bed body along the width line, and a turnover device is mounted in the through hole, which turnover device includes:

A turnover supporting block, on which a plurality of shaft pin holes are formed bilaterally on the upper side and in which two symmetric holes are equipped separately with a shaft pin, and the said turnover supporting block is fixed rotatablely in the through holes with shaft pin;

A deflector rod inserted into a slit opened in the lower portion of the turnover supporting block along the center line, and the other end of said deflector rod connects to a deflector arm and the other end of said deflector arm connects to a load transfer device which enable the turnover supporting block to turn left and right around the shaft pin.

In the middle lower portion of the mattress of the said bed body, a hole is opened with a defecation device underneath, which defecation device includes:

A porefilling pad contained in the bole and having a sleeve formed on its bottom surface;

A spacer sleeve provided between the porefilling pad and the mattress, and the said spacer sleeve is installed on the electromotive bed through fixed parts on its lateral side, on each fixed part a spring being hitched;

A sealed cowling fixed on the soleplate under the hole and with a closestool connecting hermetically to its bottom;

A mechanical linkage connecting rotatablely to the porefilling pad via the sleeve and further connecting to a power installation.

As an improvement of this invention, the said turnover supporting block is in a shape of peach and has a thickness of 4-12 cm; the turnover contact surface of the upper end face of the said turnover supporting block is lower than the surface of the mattress; an idler wheel is set up between the said deflector rod and the slit. A water nozzle that can rotate around a shaft is installed at the side of the hole within the said sealed cowling. A window is also opened on the said sealed cowling, which window connects to a warm air assembly consisting of photocatalyst filter screen, an electric fan, heating cord and a movable throttle.

Four shaft pin supporting plates are installed correspondingly at the four corners on the longer sidewalls of the said through hole, and gullet is formed on the upside of the supporting plate; The upper side of the said turnover supporting block is provided bilaterally with more than 2 shaft pill holes, and two ends of two shaft pin installed symmetrically in the holes are locked correspondingly into the gullet of the shaft pin supporting plate.

As another improvement of this invention, two shaft pin supporting plates in the shape of crossbar are installed correspondingly on the longer sidewall of the said through hole, and gullet is formed on the upside of the supporting plate; both ends of the said two shaft pins setting symmetrically protrude from the surface of the turnover supporting block and are locked respectively in the corresponding gullets of the two shaft pin supporting plates. In this way, the turnover supporting block can be fixed rotatablely between the two shaft pin supporting plates in the shape of crossbar through the shaft pins.

The said load transfer device includes a rotating shaft fixed on the electromotive bed, and a deflector arm and a first gear are fixed coaxially oil the rotating shaft, an end of the said deflector arm connects to a deflector rod inserted into the slit; the said first gear engages with a first rack rod, and one end of the first rack rod connects; to a first unit head which can move back and forth in a straight line.

The said mechanical linkage device includes:

Two cross rods passing respectively through the sleeves formed parallelly at two sides of the bottom surface of the porefilling pad, and a crank is fixed on each of four ends of the two cross rods, and a minor axis is fixed on another end of the said crank;

Four bearing blocks fixed on the electromotive bed, and each of the said four minor axes pass respectively through a bearing block and is fixed rotatablely;

Four second gears fixed respectively on the ports where the four minor axes protrude from the bearing blocks;

Two second rack rods engaging with two second gears located in the same side of the cross rod, and the said two second rack rods are mounted symmetrically through a bearing rod on a second unit head that can move back and forth in a straight line.

As the further improvement of this inventions, a second gear is fixed on the end of the said minor axis passing trough sequentially the sealed cowling, bearing block; the said porefilling pad and the crank, cross rod of the mechanical linkage device are located within the sealed cowling; a leg lowering down device is set up at the leg section of the said electromotive bed. The lower opening of the said sealed cowling couples removably and hermetically with the closestool.

The multifunction electromotive bed of this invention also provides the action of lowering down legs to make the user obtain normal sitting position in addition to the back raising function of the existing electromotive bed. On the other hand, 2-3 turnover supporting blocks that can waggle are configured to make every part of the human body contact the surface of the electromotive bed in turn, and therefore to make each part of the body get effective ventilation to avoid the occurence of bedsore. At the same time, a defecation hole on the surface of the electromotive bed, a moveable porefilling pad, a spacer sleeve, a sealed cowling and a closestool etc., are configured, and a flushing device, a warm air drying device, a circulating deodorization device and/or a sterilization device can be further added.

The advantages of this invention are that the electromotive bed which can turn the human body over and has a closestool not only enable the users keeping to the electromotive bed to carry out the operation of starting and using by themselves with the turnover supporting blocks which enable the users to turn over freely lying on the electromotive beds and with the defecation device which enables users to relieve themselves by themselves lying on the electromotive beds when they want to turn over or relieve themselves, but also provides the cleaning, drying and ventilating measures so that guarantee the people keeping to bed for a long time not suffering from bedsore, and also enable the patients relieve themselves comfortably on the electromotive bed in sitting position so as to prevent maximally effluvium from overflowing. Therefore, the use of the electromotive bed according to the invention that can turn over and has a closestool can relieve the nursing personnel of the full-time nurse and care and improve considerably the nursing condition for the patients unconscious and losing all of their mobility.

In addition, this invention is simple in structure, convenient for use and with good cleaning effect, and the products have low price and are suitable for common family. Furthermore, The products operate gently, are convenient to use and without any hazard.

### BRIEF DESCRIPTION OF DRAWINGS

FIG. 1 is the integral structural representation of the electromotive bed capable of turnover and having a closestool invention;

FIG. 2 is the structural representation of the electromotive bed invention which is adjusted into the sitting position;

FIG. 3 is the integral structural representation of the mattress of the electromotive bed according to the invention;

FIG. 4 is the structural representation of the turnover supporting block in the electromotive bed according to the invention;

FIG. 5 is the using state view of the turnover supporting block in the electromotive bed according to the invention;

FIG. 6 is the using state view of the porefilling pad in the electromotive bed according to the invention;

FIG. 7 is the using state view of one example of the turnover supporting block in the electromotive bed according to the invention;

FIG. 8 is the using state view of one example of the porefilling pad in the electromotive bed according to the invention;

FIG. 9 is the structural representation of one example of the mechanical linkage device in the electromotive bed according to the invention;

FIG. 10 is the structural representation of one example of the spacer sleeve at the opening of the electromotive bed according to the invention.

Designation of the reference number:

| | |
|---|---|
| 1. Mattress | 2 Through hole |
| 3. Hole | 4. Turnover supporting block |
| 5. Shaft pin hole | 6. Shaft pin |
| 7. Slit | 8. Turnover contact surface |
| 9. Spacer sleeve | 13. Fixed part |
| 14. Shaft pin supporting plate | 15. Gullet |
| 16. Deflector rod | 17. Deflector arm |
| 18. Porefilling pad | 19. Spring |
| 20. Sealed cowling | 21. Closestool |
| 22. Rotating shaft | 23. Primary gear |
| 24. First rack rod | 25. First unit head |
| 26. Spray pipe | 27. Shaft |
| 28. Second unit head | 29. Warm air assembly |
| 30. Bearing rod | 31. Sleeve |
| 32. Cross rod | 33. Crank |
| 34. Minor axis | 35. Second gear |
| 36. Second rack rod | 37. bearing block |

### DETAILED DESCRIPTION OF THE EMBODIMENTS

### EXAMPLE 1

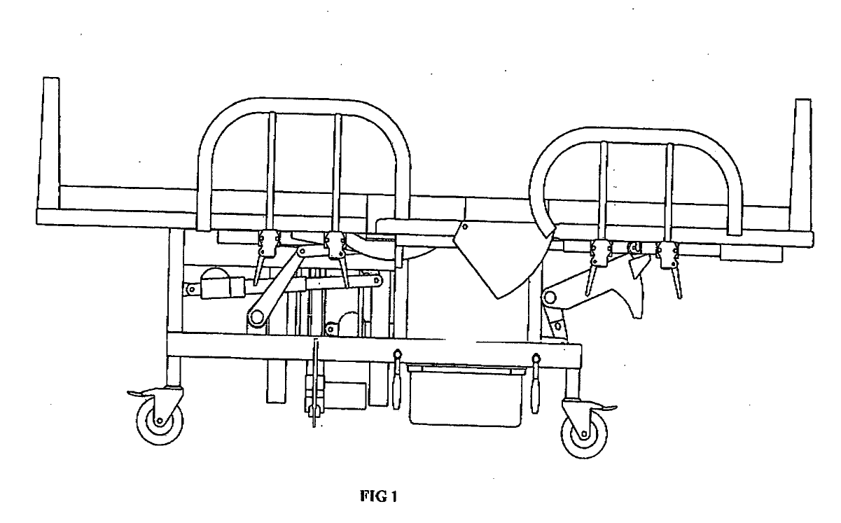

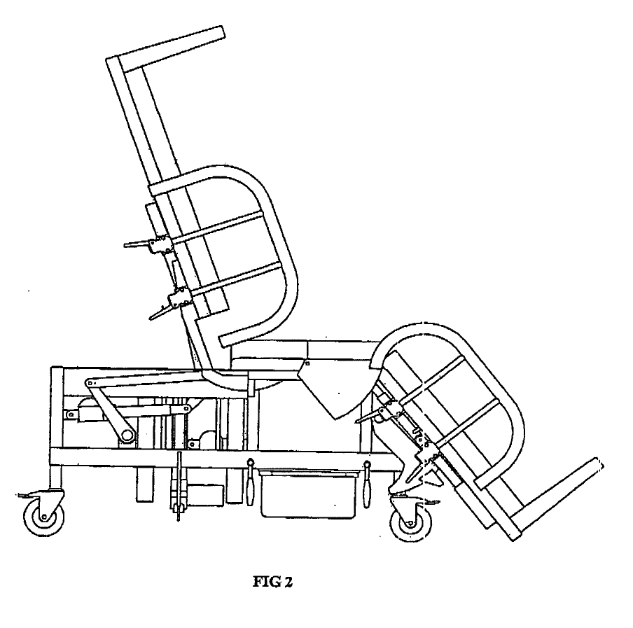

As shown in FIGS. 1 and 2, the electromotive bed of the example includes a back raising device and a leg lowering down device, thus it enable the patient relieve himself comfortably on the electromotive bed in sitting position.

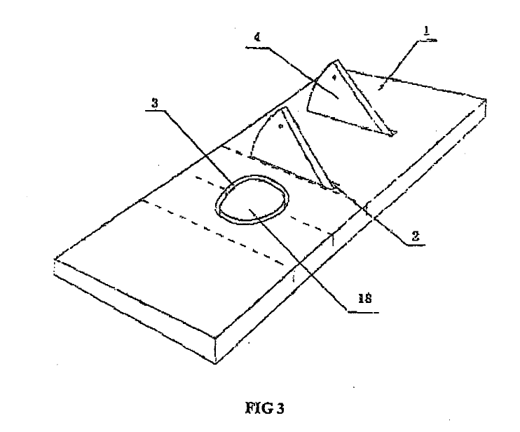

As shown in FIG. 3, two rectangular through holes 2 are opened in the middle upper portion of the mattress 1 along its width line, and a bole 3 for defection is opened at an appropriate position in the middle lower portion; a turnover supporting block 4 is installed in each through hole 2, and the lateral of the turnover supporting block 4 is perpendicular to the axial line of the electromotive bed.

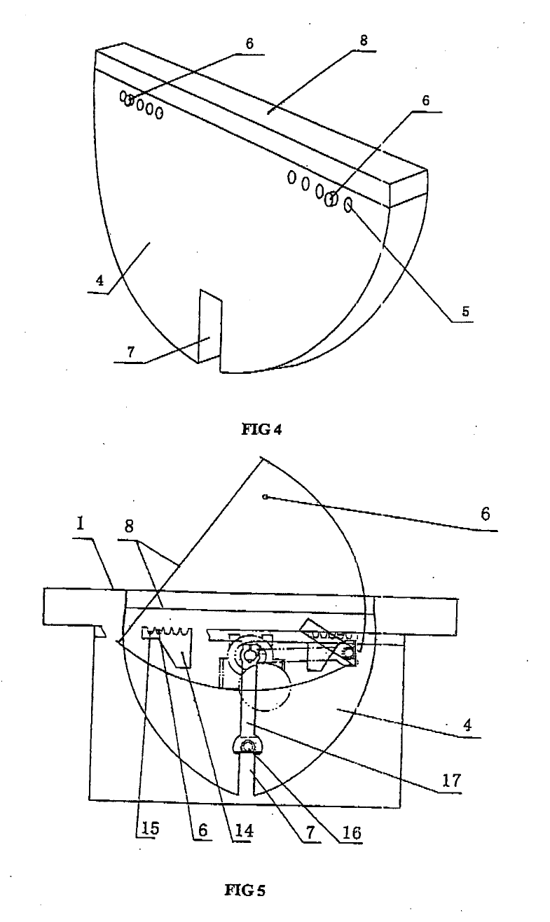

As shown in FIG. 4, five shaft pin holes 5 are formed symmetrically on both left and right sides of the upper end of peach-shape turnover supporting block 4, and shaft pins 6 are installed in the second shaft pit holes 5 from outside respectively, a slit 7 is opened at the nose bit of the turnover supporting block along the center line.

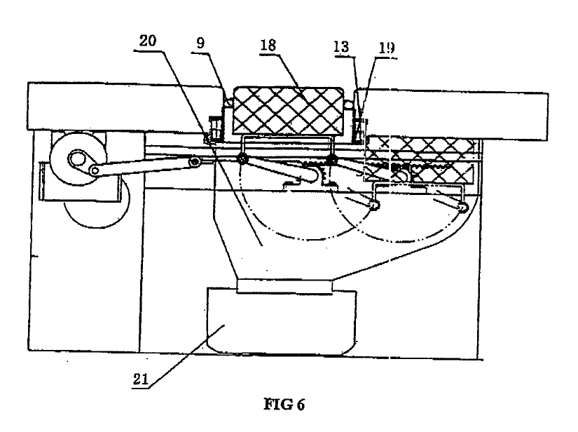

As shown in FIG. 5, a shaft pin supporting plate 14 is fixed to each end of the two oppositing longer side edge of the inner wall of through hole 2 respectively, and each shaft pin 6 protrude from the surface of turnover supporting block 4 with their two ends and are locked correspondingly in gullets 15 of two shaft pin supporting plates 14 fixed on the electromotive bed body. In this way, the turnover supporting block 4 can be fixed rotatablely to the electromotive bed through shaft pins 6. In this example, the turnover supporting blocks 4 have a width of 8 cm and its turnover contact surface 8 is lower than the mattress surface to ensure the ventilation of back and comfortable use.

A deflector rod 16 is inserted into the slit of the said turnover supporting block 4, and one end of the deflector rod 16 fixes vertically a deflector arm 17. Meanwhile another end of the defector arm 17 connects to a load transfer device with which the turnover supporting block 4 can be overturned to left around the shaft pin 6 at the left side or overturned to right around the shaft pin 6 at the right side.

The turnover supporting block 4 in peach shape can prevent the clothing of the people lying on the electromotive bed from being caught or his skin being injured during service. Staring up the load transfer device to drive the deflector arm to rotate, and through the deflector arm, the deflector rod move to drive the turnover supporting block 4 turn around the shaft pin 6 fixed in the shaft pin hole 5, and therefore, the people lying on the electromotive bed turn over. In addition, a smooth surface of the turnover supporting block 4 should be guaranteed.

As shown in FIG. 6, a porefilling pad 18 is placed in the hole 3 at the middle portion of the mattress and a spacer sleeve 9 is placed between the porefilling pad 18 and the hole 3, a sealed cowling 20 is installed under the hole 3, and a closestool 21 is connected under to the sealed cowling 20. The porefilling pad 18 connects to a mechanical linkage device through the sleeves fixed parallelly at both sides of the bottom, and a part of the mechanical linkage device is located within the sealed cowling 20. The front and rear spray pipes can also be fixed as required within the sealed cowling 20.

In this example, the turnover supporting block 4, spacer sleeve 9, sealed cowling 20 and closestool 21 are all made of plastic. The plurality of shaft pin holes 5 formed on the turnover supporting block 4 are designed for being adjusted in reference to the width of individual human body. The turnover supporting block 4 is placed on the electromotive bed after the shaft pins 6 being installed in the shaft pin holes if only the turnover supporting block 4 can be overturned normally. The load transfer device may be manufactured according to related art. The width of the turnover supporting block 4 may be selected in a range of 4-12 cm. The spray pipe 26 is connected to a tap water pipe through a solenoid electric valve, or to a tank watering manually through a water pump.

The load transfer device for controlling turnover in this product can employ the existing mechanical transmission device or hydraulic transmission device, electric transmission mechanism, etc., and the commonly used gear transmission, worm gear transmission, worm screw transmission, etc. devices in the related art can be adopted.

The lateral of the turnover supporting block 4 at the middle part of the electromotive bed is perpendicular to the axial line of the electromotive bed such an angle can ensure a comfortable sense during service. But the angle is not necessary to be 90 degree all the time. The turnover contact surface 8 should be lower than the surface of electromotive mattress, such a structure can ensure the air passing through the surface of the turnover supporting block 4 during regular use of the electromotive bed to realize ventilation as much as possible. Since the product has only 2-3 pieces of turnover supporting blocks 4, it can guarantee the turnover of the user and the sufficient ventilation of most part of his back. More than two shaft pin holes 5 is used in the product, which can guarantee the product being able to overturn to either left or right to meet the requirements of the user.

The porefilling pad 18 connects to the mechanical linkage device according with the existing mechanical connector principle. In the configuration of the product, the existing measure can be used to guarantee the porefilling pad 18 being either at a position to fill the hole 3 or a position beside one side of hole 3 under the electromotive mattress. The porefilling pad 18 is placed at hole 3 under normal condition. Since its thickness equal to that of the electromotive mattress, the porefilling pad 18 shall not affect the normal use. Start up the power installation if it is required for defecation, and the cross rod 32 drive sleeve, 31 to move under the action of the mechanical linkage device, thereby make the porefilling pad 18 moving under the electromotive bed and unclose the defecation hole for defecating.

The front and rear inner walls of the sealed cowling 20 are installed with electrically controlled spray pipes 26. Turn on the power to perform cleaning and then drying with warm air device while in use. And the inner wall of the sealed cowling 20 is also washed while water is sprayed to the relevant part of the human body during cleaning.

To avoid the electromotive mattress being wetted during flushing, this product is mounted additionally with a spacer sleeve 9. Since the top surface of the spacer sleeve 9 is lower than the surrounding mattress 1 and the porefilling pad 18 under normal condition, the human body is unlikely to contact with it while in decubitus. And when the porefilling pad 18 is moved away for defecation, the rump shall comprise the surrounding mattress 1 and contact with the moveable spacer sleeve 9, and that the moveable spacer sleeve 9 shall displace a certain distance downward supported by the elastic force of the spring 19.

### EXAMPLE 2

This example further provides a preferable scheme for the turnover part of the electromotive bed invention.

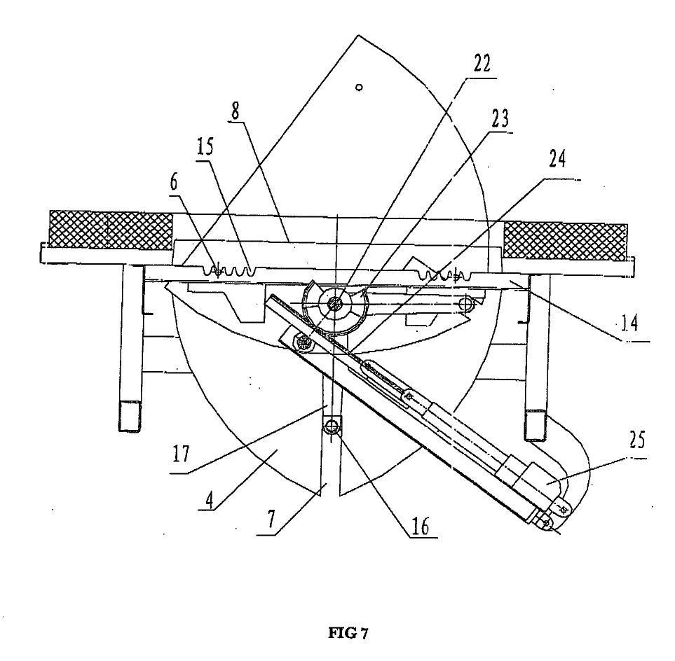

As shown in FIG. 7, two crossbar shaft pin supporting plates 14 are installed correspondingly on the longer sidewalls of the through hole 2, and the gullet is formed at the upside of the supporting palate 14; both ends of two shaft pin 6 set symmetrically protrude from the surface of the turnover supporting block 4 and are locked respectively in the gullets 15 on one end of the two shaft pin supporting plates 14; in such a way, the turnover supporting block 4 is clamped by two crossbar shaft pin supporting plates 14 and is installed stably and rotatablely on the electromotive bed through the shaft pin 6. The width of the turnover supporting block 4 in this example is 6 cm.

The load transfer device in this example includes a rotating shaft 22 fixed on the electromotive bed, and a deflector arm 17 and a first gear 23 are mounted around the rotating shaft 22; the end of the deflector arm 17 connects to a deflector rod 16 inserted into a slit 7; the first gear 23 engages with a first rack rod 24, and one end of the first rack rod 24 connects to a first unit head 25 which can move back and forth in a straight line.

The first unit head 25 drive the first rack rod 24 to move back and forth in a straight line, and the first rack rod 24 rotates backward and forward the first gear 23 engaged with it, and the rotating shaft 22 fixed on the first gear 23 drives the deflector arm 17 to waggle. In this way, the detector arm 17 drives the turnover supporting block 4 through the deflector rod 16 at one end of the deflector arm 17, and the turnover supporting block 4 waggle with the left and right shaft pins 6 as the fulcraso that the turnover contact surface 8 at the top surface of turnover supporting block 4 lift up human body to turn over.

The turnover contact surface 8 is made of soft material; symmetrical shaft pin holes 5 are formed on the turnover supporting block 4. When the shaft pins 6 are inserted into different symmetric shaft pin holes 5, the protruded length of the top surface of turnover supporting block 4 from the electromotive bed surface can be adjusted to adapt to different width of human body.

The other parts are same as in example 1.

### EXAMPLE 3

This example further provides a preferable scheme for the defecation device of the electromotive bed according to the invention.

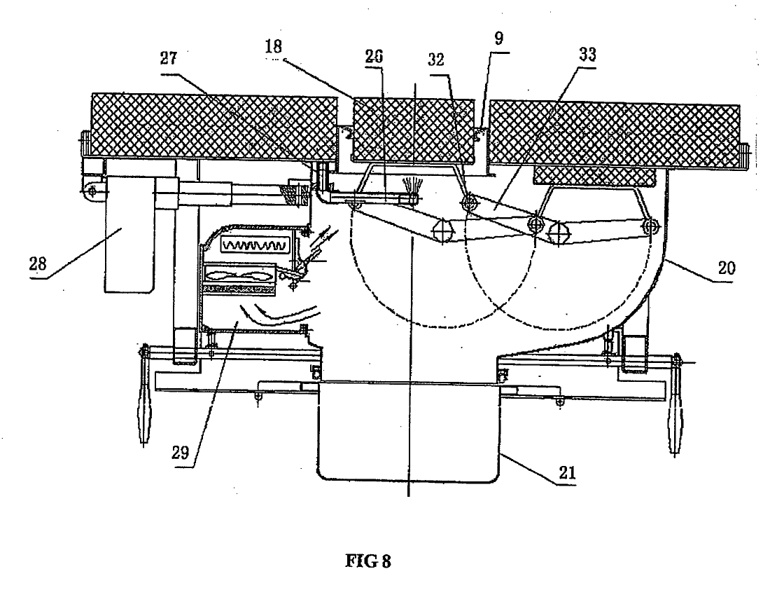

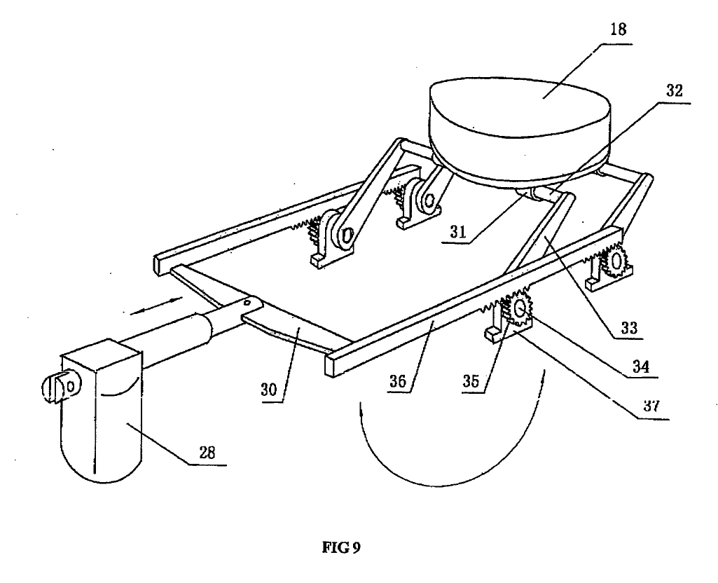

As shown in FIG. 8, the porefilling pads 18 make rotatable connects rotatablely with a cross rod 32 through four sleeves 31 (each two as a group). The cross rod 32 integrated with the crank 33, minor axis 34, second gear 35 into one block and can rotate around the bearing block 37.

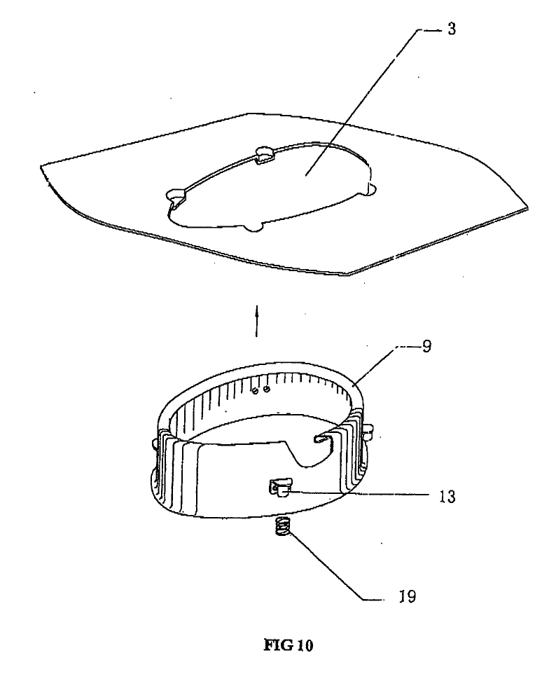

As shown in FIG. 9, the second rack rod 36 engages with the second gear 35, and further connects to and second unit head 28 through the bearing rod 30. The second unit head 28 drives the second rack rod 36 to move back and forth in a straight line, and make the second gear 35 to rotate back and forth and drive the crank 33 through the minor axis 34 fixed to the second gear 35, and further drive the cross rod 32 to waggle. In this way, the sleeves 31 formed parallelly at both sides of the bottom surface of porefilling pad 18 waggle together with the cross rod 32 along a arc track. The plane determined by the axial lines of the two cross rods 32 are always parallel with the electromotive bed surface, during the motion since two cross rods 32 are always paralleling with each other, therefore, the porefilling pad 18 keeps its top surface upward during motion, and the porefilling pad 18 shall fill and level up the hole 3 of the electromotive mattress when it moves to a stop point, while the porefilling pad 18 shall withstand the soleplate of the electromotive bed surface and be compressed so as to hide under the soleplate at one side to avoid being contaminated when it moves to another stop point. Moreover, the porefilling pad 18 moves in a subvertical direction when closing the area of electromotive bed surface, which shall not exercise a detrimental effect.

The other parts are same as in example 1.

### EXAMPLE 4

This example further provides a preferable scheme for the cleaning device of the electromotive bed according to the invention.

As shown in FIG. 10, a hole 3 is opened at the middle section of the mattress 1, and a spacer sleeve 9 which can move up and down in the hole 3 connects elastically to the soleplate of electromotive bed surface through the fixed part 13 and the springs 19. The human body shall shift downward owing to the bearing surface area reducing when the porefilling pad 18 is moved, and the circumference of the rump contact the spacer sleeve 9 and compress the spring 19. As to different body weights, spring 19 may automatically regulate the distribution of supporting force to human body by the spacer sleeve 9 and the elastic mattress 1 around to reduce the uncomfortableness of the human body.

The spacer sleeve 9 can act as a sealing device to prevent the electromotive mattress from being contaminated during defecation and flushing. The top surface of the spacer sleeve 9 shall be lower than the electromotive bed surface and not contact human body while the porefilling pad 18 being closed. The sealed cowling 20 closely fitting to the soleplate of electromotive bed surface is under the spacer sleeve 9, and the lower opening of the sealed cowling 20 is connected moveably and tightly to the closestool 21.

The minor axis 34 in the motion device of tie porefilling pad 18 passes through the sealed cowling 20 and the bearing block 37 respectively with its inner end connecting to the crank 33 and outer end to the second gear 35, and can rotate around the bearing block 37. In this way, the porefilling pad and the cranks, cross rods of the mechanical linkage device shall be within the sealed cowling.

In this example, a water nozzle 26 which can rotate around the shaft 27 is installed at one side of the hole 3 opened on the soleplate of electromotive bed surface within the sealed cowling 20. The water nozzle 26 shall be rotated to aim at the location to be flushed and start spraying while in operation, and the water nozzle 26 can wiggle in a small range to flush different location during spraying. The water nozzle 26 shall be rotated for 90 degrees and hidden at the lateral of hole 3 to avoid being contaminated after the operation.

On the other hand, the sealed cowling 20 is opened with a window connected to a warm air assembly 29, which includes: photocatalyst filter screen, an electric fan, heating cord and moveable throttle. The fan shall be tuned on to the high shift and the heating cord be powered on while performing drying after flushing. Here air enter into the warm air assembly 29 from the sealed cowling 20, and pass through the filter screen, the electric fan and the heating cord, blow open the moveable throttle and finally blow to the rump of the human body. The heating cord shall not be powered on and the fan turned on to low shift while drying is not required. Here wind can not blow open the moveable throttle and the air only flows out from the circumference gap to realize the circulating deodorization and sterilization.

The bottom of the defecation device in this invention can also be changed into a sewerage, and the water source for flushing may be connected to a tap water pipe or a water-storage tank watered manual. But the flushing water has to be turned into the water with moderate temperature by a temperature adjustable heater, and the temperature of warm air for drying should also be adjustable.

The other parts are same as in example 1.

1. An electromotive bed, including a bed body, characterized in that 2-3 rectangular through holes (2) are opened in the middle-upper portion of the mattress (1) of the said bed body along the width line, and a turnover device is mounted in the through hole (2), which turnover device includes:
A turnover supporting block (4), on which a plurality of shaft pin holes (5) are formed bilaterally on the upper side and in which two symmetric holes (5) are equipped separately with a shaft pin (6), and the said turnover supporting block (4) is fixed rotatablely in the through holes (2) with shaft pin (6);
A deflector rod (16) inserted into a slit (7) opened in the lower portion of the turnover supporting block (4) along the center line, and the other end of said deflector rod (16) connects to a deflector arm (17) connecting to a load transfer device.

2. The electromotive bed of claim 1, characterized in that the said turnover supporting block (4) is in a shape of peach and has a thickness of 4-12 cm.

3. The electromotive bed of claim 1, characterized in that the turnover contact surface (8) of the upper end face of the said turnover supporting block (4) is lower than the surface of the mattress (1).

4. The electromotive bed of claim 1, characterized in that an idler wheel is set up between the said deflector rod (16) and the slit (7).

5. The electromotive bed of claim 1, characterized in that four shaft pin supporting plates (14) are installed correspondingly at the four corners on the longer sidewalls of the said through hole (2), and gullet (15) is formed on the upside of the supporting plate (14);
The upper side of the said turnover supporting block (4) is provided bilaterally with more than 2 shaft pin holes (5), and two ends of two shaft pin (6) installed symmetrically in the holes are locked correspondingly into the gullet (15) of the shaft pin supporting plate (14).

6. The electromotive bed of claim 1, characterized in that two shaft pin supporting plates (14) in the shape of crossbar are installed correspondingly on the longer sidewall of the said through hole (2), and gullet (15) is formed on the upside of the supporting plate (14); both ends of the said two shaft pins (6) setting symmetrically protrude from the surface of the turnover supporting block (4) and are locked respectively in the corresponding gullets (15) of the two shaft pins supporting plates (14).

7. The electromotive bed of claim 1, characterized in that the said load transfer device includes a rotating shaft (22) fixed on the electromotive bed, and a deflector arm (17) and a first gear (23) are fixed coaxially on the rotating shaft (22);
An end of the said deflector arm connects to a deflector rod (16) inserted into the slit (7);
The said first gear (23) engages with a first rack rod (24), and one end of the first rack rod connects to a first unit head (25) which can move back and forth in a straight line.

8. The electromotive bed of any one of claim 1, characterized in that in the middle lower portion of the mattress (1) of the said bed body, a hole (3) is opened with a defecation device underneath, which defecation device includes:
A porefilling pad (18) contained in the hole (3) and having a sleeve (31) formed on its bottom surface;
A spacer sleeve (9) provided between the porefilling pad (18) and the mattress (1), and the said spacer sleeve (9) is installed on the electromotive bed through fixed parts (13) on its lateral side, on each fixed part (13) a spring (19) being hitched;
A sealed cowling (20) fixed on the soleplate under the hole (3) and with a closestool (21) connecting hermetically to its bottom;
A mechanical linkage connecting to the porefilling pad (18) via the sleeve (31) and further connecting to a power installation.

9. The electromotive bed of claim 8, characterized in that a water nozzle (26) that can rotate around a shaft (27) is installed at the side of the hole (3) within the said sealed cowling (20).

10. The electromotive bed of claim 8, characterized in that a window is opened on the said sealed cowling (20), which window connects to a warm air assembly (29) consisting of photocatalyst filter screen, an electric fan, heating cord and a movable throttle.

11. The electromotive bed of claim 8, characterized in that the said mechanical linkage device includes:
Two cross rods (32) passing respectively through the sleeves (31) formed parallelly at two sides of the bottom surface of the porefilling pad (18), and a crank (33) is fixed on each of four ends of the two cross rods (32), and a minor axis (34) is fixed on another end of the said crank (33);
Four bearing blocks (37) fixed on the electromotive bed, and each of the said four minor axes (34) pass respectively through a bearing block (37) and is fixed rotatablely;
Four second gears (35) fixed respectively on the ports where the four minor axes (34) protrude from the bearing blocks (37);
Two second rack rods (36) engaging with two second gears (35) located in the same side of the cross rod (32), and the said second rack rods (36) are mounted symmetrically through a bearing rod (30) on a second unit head (28) that can move back and forth in a straight line.

12. The electromotive bed of claim 11, characterized in that a second gear (35) is fixed on the end of the said minor axis (34) passing through sequentially the sealed cowling (20), bearing block (37);
The said porefilling pad (18) and the crank (33), cross rod (32) of the mechanical linkage device are located within the sealed cowling (20).

13. The electromotive bed of claim 8, characterized in that a leg lowering down device is set up at the leg section of the electromotive bed.
